(19) United States
(12) Patent Application Publication
(10) Pub. No.: US 2025/0119943 A1
(43) Pub. Date: Apr. 10, 2025

(54) PERFORMING LISTEN-BEFORE-TALK OPERATIONS FOR PHYSICAL SIDELINK FEEDBACK CHANNEL TRANSMISSIONS

(71) Applicant: Lenovo (Singapore) Pte. Ltd., New Tech Park (SG)

(72) Inventors: Karthikeyan Ganesan, Kronberg im Taunus (DE); Alexander Golitschek Edler von Elbwart, Darmstadt (DE); Joachim Löhr, Wiesbaden (DE); Prateek Basu Mallick, Dreieich (DE); Vijay Nangia, Woodridge, IL (US); Ravi Kuchibhotla, Chicago, IL (US)

(21) Appl. No.: 18/833,327

(22) PCT Filed: Jan. 26, 2023
(86) PCT No.: PCT/IB2023/050695

§ 371 Date: Jul. 25, 2024

Related U.S. Application Data
(60) Provisional application No. 63/303,343, filed on Jan. 26, 2022.

(51) Int. Cl. H04W 74/0808; H04W 72/25

(52) U.S. Cl. CPC H04W 74/0808; H04W 72/25

(57) ABSTRACT

Apparatuses, methods, and systems are disclosed for performing listen-before-talk operations for physical sidelink feedback channel transmissions. One method includes performing, at a user equipment (“UE”), a listen-before-talk (“LBT”) operation for a physical sidelink feedback channel (“PSFCH”) transmission. The method includes receiving configuration information for performing the LBT operation for the PSFCH transmission. The method includes determining the LBT operation for the PSFCH. A category (“CAT”) 4 LBT is performed at a beginning of a slot before a physical sidelink shared channel (“PSSCH”) symbol, before a PSFCH symbol, using a short control signaling exemption rule, or a combination thereof.

### FIELD

The subject matter disclosed herein relates generally to wireless communications and more particularly relates to performing listen-before-talk (“LBT”) operations for physical sidelink feedback channel (“PSFCH”) transmissions.

### BACKGROUND

In certain wireless communications networks, LBT may be performed. In such networks, LBT failures may occur.

### BRIEF SUMMARY

Methods for performing LBT operations for physical sidelink feedback channel transmissions are disclosed. Apparatuses and systems also perform the functions of the methods. One embodiment of a method includes performing, at a user equipment, a LBT operation for a physical sidelink feedback channel (PSFCH) transmission. In some embodiments, the method includes receiving configuration information for performing the LBT operation for the PSFCH transmission. In certain embodiments, the method includes determining the LBT operation for the PSFCH. A category (Cat) 4 LBT is performed at a beginning of a slot before a physical sidelink shared channel (PSSCH) symbol, before a PSFCH symbol, using a short control signaling exemption rule, or a combination thereof.

One apparatus for performing LBT operations for physical sidelink feedback channel transmissions includes a user equipment. In some embodiments, the apparatus includes a processor that performs a LBT operation for a physical sidelink feedback channel (PSFCH) transmission. In various embodiments, the apparatus includes a receiver that receives configuration information for performing the LBT operation for the PSFCH transmission. The processor determines the LBT operation for the PSFCH. A category (Cat) 4 LBT is performed at a beginning of a slot before a PSSCH symbol, before a PSFCH symbol, using a short control signaling exemption rule, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing LBT operations for physical sidelink feedback channel transmissions;

FIG. 2 is a schematic block diagram illustrating one embodiment of an apparatus that may be used for performing LBT operations for physical sidelink feedback channel transmissions;

FIG. 3 is a schematic block diagram illustrating one embodiment of an apparatus that may be used for performing LBT operations for physical sidelink feedback channel transmissions;

FIG. 4 is a schematic block diagram illustrating one embodiment of a method for LBT operation for PSFCH;

FIG. 5 is a schematic block diagram illustrating one embodiment of a sidelink slot structure;

FIG. 6 is a schematic block diagram illustrating one embodiment of a method for PSFCH transmission using LBT and a short control signaling exemption;

FIG. 7 is a schematic block diagram illustrating one embodiment of a Cat 2 LBT within a sidelink slot structure;

FIG. 8 is a schematic block diagram illustrating one embodiment of COT sharing for PSFCH transmission within a sidelink slot structure; and

FIG. 9 is a flow chart diagram illustrating one embodiment of a method for performing LBT operations for physical sidelink feedback channel transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

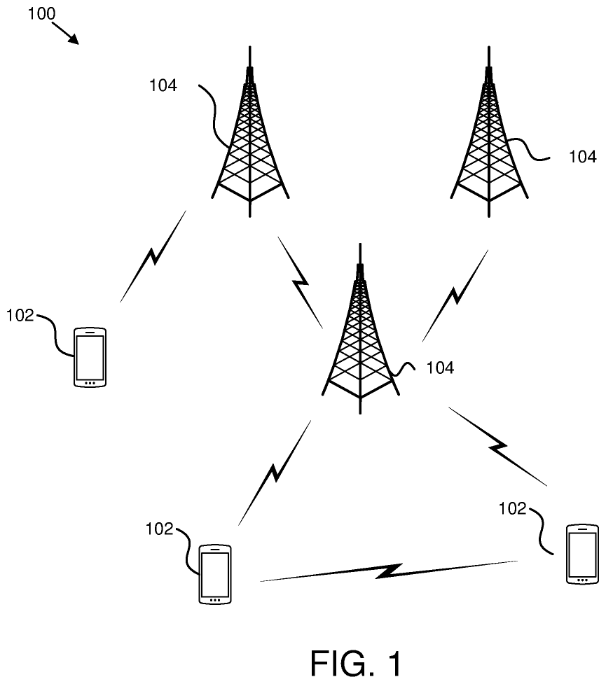

FIG. 1 depicts an embodiment of a wireless communication system 100 for performing LBT operations for PFSCH transmissions. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 (e.g., a UE) may perform an LBT operation for a PSFCH transmission. In some embodiments, the remote unit 102 may receive a configuration for performing the LBT operation for the PSFCH transmission. For example, the remote unit 102 may receive, from a network unit 104 or another remote unit 102, a message including the configuration for performing the LBT operation for the PSFCH transmission. In some embodiments, the message may be a radio resource control (RRC) message, a downlink control information (DCI), a medium access control-control element (MAC-CE), sidelink control information (SCI), or the like. In certain embodiments, the remote unit 102 may determine the LBT operation for the PSFCH transmission, for example, based at least in part on the received configuration.

In some embodiments, an LBT may be associated with a category. For example, a remote unit 102 may perform a category (CAT) 4 LBT at one or more beginning symbols of a slot, for example before one or more symbols associated with a PSSCH transmission, or before one or more symbols associated with the PSFCH transmission, or a combination thereof. The remote unit 102 may perform the CAT 4 LBT, in some embodiments, using a short control signaling exemption rule. Accordingly, the remote unit 102 may be configured for performing an LBT operation for a PSFCH transmission. In various embodiments, a short control signal exemption rule may include that: within an observation period of 50 ms, a number of short control signaling transmissions by a UE shall be equal to or less than 50; and the total duration of the equipment's short control signaling transmissions shall be less than 2 500 μs within the observation period.

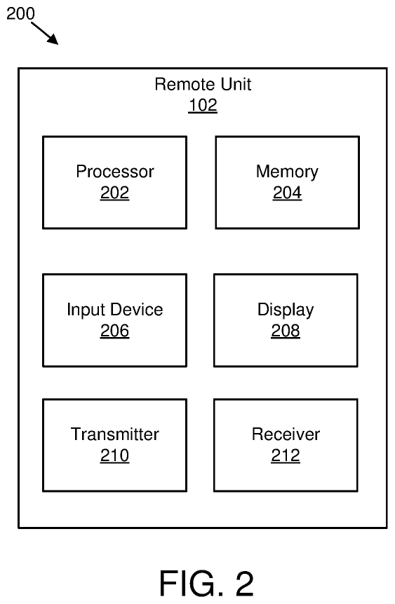

FIG. 2 depicts one embodiment of an apparatus 200 that may be used for performing LBT operations for PSFCH transmissions. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 performs an LBT operation for a PSFCH transmission. In various embodiments, the receiver 212 receives a configuration (also referred to as configuration information) for performing the LBT operation for the PSFCH transmission. The processor 202 determines the LBT operation for the PSFCH. The processor 202 may perform a CAT 4 LBT at one or more beginning symbols of a slot before one or more symbols associated with a PSSCH transmission, or before one or more symbols associated with the PSFCH transmission, or a combination thereof. Additionally, or alternatively, the processor 202 may perform a CAT 4 LBT using a short control signaling exemption rule.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

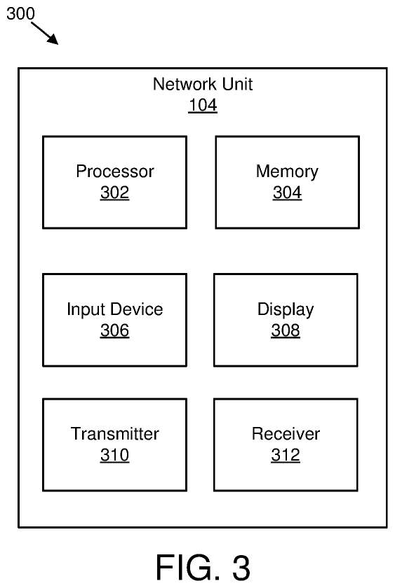

FIG. 3 depicts one embodiment of an apparatus 300 that may be used for performing LBT operations for PSFCH transmissions. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, sidelink unlicensed operation may be used and there may be a one shot hybrid automatic repeat request (“HARQ”) feedback procedure for sidelink unlicensed operation.

In some embodiments, as part of new radio (“NR”) unlicensed (“U”) (“NR-U”) HARQ feedback enhancement to counter LBT failure handling non-numerical value as feedback timing which eventually postpone the feedback timing, there may be a downlink feedback indicator providing explicit HARQ feedback reception at a network unit (e.g., an eNB, a gNB) and type 3 codebook enhancement that is one shot HARQ feedback reporting.

In various embodiments, a sidelink HARQ feedback procedure requires enhancement considering LBT operations for PSFCH transmission where LBT failure might delay the HARQ feedback. In certain embodiments, various LBT operations for PSFCH transmission are considered using CAT 4 LBT (e.g., short control exemption signaling).

In certain embodiments, for one-shot HARQ feedback: new data indicator (“NDI”) can be configured to be part of one-shot HARQ feedback. If NDI is configured: 1) the latest NDI value detected by a remote unit 102 (e.g., a UE) is reported along with HARQ-ACK for the corresponding HARQ process ID—the remote unit 102 (e.g., the UE) assumes NDI=0 if there is no prior NDI value for the HARQ process; and/or 2) NDI is included for each transport block (“TB”). If NDI is not configured: 1) NDI value is not reported along with HARQ-ACK for the corresponding physical downlink shared channel (“PDSCH”); and/or 2) the remote unit 102 (e.g., the UE) is expected to reset HARQ-ACK state (as discontinuous transmission (“DTX”) or non-acknowledgement (“NACK”)) for a HARQ process ID once acknowledgement (“ACK”) is reported for the same HARQ process ID in the previous feedback. In some embodiments, code block group (“CBG”)-based HARQ-ACK or TB-based HARQ-ACK can be configured to be part of the one-shot HARQ feedback for the component carriers (“CCs”) configured with a CBG. It should be noted that for any HARQ ID that is scheduled after the last determined PDSCH for which ACK/NACK decoding result is reported, the remote unit 102 (e.g., the UE) does not use this PDSCH for one-shot HARQ codebook composition.

In various embodiments, in a one-shot codebook, the NDI follows the HARQ-ACK information for each TB. In certain embodiments, in the one-shot codebook, the ordering of information for HARQ-ACK and NDI is as follows: 1) CBG index; 2) TB index; 3) HARQ process ID; and/or 4) serving cell index.

In some embodiments, for a DCI requesting one-shot HARQ-ACK feedback without scheduling PDSCH, the minimum processing time of the DCI requesting one shot HARQ-ACK feedback can be the same as that of the processing time of DCI carrying an SPS release. In various embodiments, an intended behavior according to NR-U agreements is commonly understood: 1) Type-3 CB can be triggered and reported when no DCI indicated a non-numerical HARQ feedback (“NNK1”) value; 2) Type-3 CB can report HARQ-ACK information for a PDSCH scheduled with NNK1 when a remote unit 102 (e.g., a UE) is configured with type-1 CB; and/or 3) Type-1 CB cannot report HARQ-ACK information for a PDSCH scheduled with NNK1.

In certain embodiments, if a remote unit 102 (e.g., a UE) is provided pdsch-HARQ-ACK-OneShotFeedback, the remote unit 102 determines õ₀^{ACK}, õ₁^{ACK}, . . . , õ_{O}_{_{ACK}}₋₁^{ACK} HARQ-ACK information bits, for a total number of O_{ACK} HARQ-ACK information bits, of a Type-3 HARQ-ACK codebook according to the following procedure, with the following: 1) set N_{cells}^{DL} to the number of configured serving cells; 2) set N_{HARQ,c}^{DL} to the value of nrofHARQ-ProcessesForPDSCH for serving cell c, if provided; else, set N_{HARQ,c}^{DL}=8; 3) set N_{TB,c}^{DL} to the value of maxNrofCodeWordsScheduledByDCI for serving cell c if harq-ACK-SpatialBundlingPUCCH is provided and NDI_{HARQ}=0, or if harq-ACK-SpatialBundlingPUCCH is not provided, or if maxCodeBlockGroupsPerTransportBlock is provided for serving cell c; else, set N_{TB,c}^{DL}=1; 4) set N_{HARQ-ACK,c}^{CBG/TB,max} to the number of HARQ-ACK information bits per TB for PDSCH receptions on serving cell c if maxCodeBlockGroupsPerTransportBlock is provided for serving cell c and pdsch-HARQ-ACK-OneShotFeedbackCBG is provided; else, set N_{HARQ-ACK,c}^{CBG/TB,max}=0; 5) set NDI_{HARQ}=0 if pdsch-HARQ-ACK-OneShotFeedbackNDI is provided; else set NDI_{HARQ}=1; 6) set c=0—serving cell index; 7) set h=0—HARQ process number; 8) set t=0—TB index; 9) set g=0—CBG index; 10) set j=0, while c<N_{cells}^{DL}, while h<N_{HARQ,c}^{DL}, if NDI_{HARQ}=0, if N_{HARQ-ACK,c}^{CBG/TB,max}>0, while t<N_{TB,c}^{DL}, while g<N_{HARQ-ACK,c}^{CBG/TB,max}, õⱼ^{ACK}=HARQ-ACK information bit for CBG g of TB t for HARQ process number h of serving cell c, if any; else, õⱼ^{ACK}=0, j=j+1, g=g+1, end while, õⱼ^{ACK}=NDI value indicated in the DCI format corresponding to the HARQ-ACK information bit(s) for TB t for HARQ process number h on serving cell c, if any; else, õⱼ^{ACK}=0, g=0, j=j+1, t=t+1, end while, else, while t<N_{TB,c}^{DL}, õⱼ^{ACK}=HARQ-ACK information bit for TB t for HARQ process h of serving cell c, if any; else, õⱼ^{ACK}=0, j=j+1, õⱼ^{ACK}=NDI value indicated in the DCI format corresponding to the HARQ-ACK information bit(s) for TB t for HARQ process number h on serving cell c, if any; else, õⱼ^{ACK}=0, j=j+1, t=t+1, end while, end if, t=0, else, if N_{HARQ-ACK,c}^{CBG/TB,max}>0 while t<N_{TB,c}^{DL}, if the remote unit 102 (e.g., the UE) has obtained HARQ-ACK information for TB t for HARQ process number h on serving cell c corresponding to a PDSCH reception and has not reported the HARQ-ACK information corresponding to the PDSCH reception, while g<N_{HARQ-ACK,c}^{CBG/TB,max}, õⱼ^{ACK}=HARQ-ACK information bit for CBG g of TB t for HARQ process number h of serving cell c, j=j+1, g=g+1, end while, else, while g<N_{HARQ-ACK,c}^{CBG/TB,max}, õⱼ^{ACK}=NACK=+1,g=g+1, end while, end if, g=0, t=t+1, end while, else, while t<N_{TB,c}^{DL}, if the remote unit 102 (e.g., the UE) has obtained HARQ-ACK information for TB t for HARQ process number h on serving cell c corresponding to a PDSCH reception and has not reported the HARQ-ACK information corresponding to the PDSCH reception, if harq-ACK-SpatialBundlingPUCCH is not provided, õⱼ^{ACK}=HARQ-ACK information bit for TB t for HARQ process h of serving cell c, else, õⱼ^{ACK}=binary AND operation of the HARQ-ACK information bits corresponding to first and second transport blocks for HARQ process h of serving cell c. If the remote unit 102 (e.g., the UE) receives one TB, the remote unit 102 (e.g., the UE) assumes ACK for the second TB, end if, j=j+1, t=t+1, else, õⱼ^{ACK}=NACK, j=j+1, t=t+1, end if, end while, end if, t=0, end if, h=h+1, end while, h=0, c=c+1, end while.

In some embodiments, if N_{TB,c}^{DL}>1, when a remote unit 102 (e.g., a UE) receives a PDSCH with one TB, the HARQ-ACK information is associated with the first TB.

In various embodiments, if a remote unit 102 (e.g., a UE) receives a SPS PDSCH, or a PDSCH that is scheduled by a DCI format that does not support CBG based PDSCH receptions for a serving cell c and if maxCodeBlockGroupsPerTransportBlock is provided for serving cell c, and pdsch-HARQ-ACK-OneShotFeedbackCBG is provided, the remote unit 102 (e.g., the UE) repeats N_{HARQ-ACK,c}^{CBG/TB,max} times the HARQ-ACK information for the TB in the PDSCH.

In certain embodiments, if a remote unit 102 (e.g., a UE) detects a DCI format that includes a one-shot HARQ-ACK request field with value 1, the remote unit 102 (e.g., the UE) determines a physical uplink control channel (“PUCCH”) or a physical uplink shared channel (“PUSCH”) to multiplex a Type-3 HARQ-ACK codebook for transmission in a slot. The remote unit 102 (e.g., the UE) multiplexes only the Type-3 HARQ-ACK codebook in the PUCCH or the PUSCH for transmission in the slot.

In some embodiments, if. 1) a remote unit 102 (e.g., a UE) detects a DCI format that includes a one-shot HARQ-ACK request field with value 1; and 2) the cyclic redundancy check (“CRC”) of the DCI is scrambled by a cell radio network temporary identifier (“RNTI”) (“C-RNTI”) or an modulation and coding scheme (“MCS”) C-RNTI (“MCS-C-RNTI”); and 3) resourceAllocation=resourceAllocationType0 and all bits of the frequency domain resource assignment field in the DCI format are equal to 0; or 4) resourceAllocation=resourceAllocationType1 and all bits of the frequency domain resource assignment field in the DCI format are equal to 1; or 5) resourceAllocation=dynamicSwitch and all bits of the frequency domain resource assignment field in the DCI format are equal to 0 or 1.

In various embodiments, a DCI format provides a request for a Type-3 HARQ-ACK codebook report and does not schedule a PDSCH reception. The remote unit 102 (e.g., the UE) is expected to provide HARQ-ACK information in response to the request for the Type-3 HARQ-ACK codebook after N symbols from the last symbol of a physical downlink control channel (“PDCCH”) providing the DCI format, where the value of N for μ=0, 1, 2 by replacing “SPS PDSCH release” with “DCI format.”

In some embodiments, there may be various LBT operations for PSFCH transmission. In such embodiments, CAT 4 LBT operation at the beginning of the slot for PSSCH transmission is performed and, if LBT is successful, PSSCH is transmitted while PSFCH is transmitted after performing CAT 2 LBT when the gap is more than 16 to 25 μs.

In various embodiments, if LBT fails, PSFCH transmission may be performed using a short control signaling exemption rule. In such embodiments, CAT 4 LBT, before the PSFCH transmission whose channel access priority class (“CAPC”) priority for initiating the channel occupancy, might be a priority of a corresponding PSSCH for which HARQ-ACK is generated for transmission.

In certain embodiments, CAPC priority for PSFCH may be configured (or preconfigured). In such embodiments, CAT 4 LBT is always performed before the PSFCH transmission. LBT failure may result in a PSFCH transmission according to a short control signaling exemption rule. In some embodiments, PSFCH transmission within a carrier occupancy (“CO”) duration may not be counted for a short control signaling exemption window duration.

In various embodiments, PSFCH feedback may be transmitted within a set of symbols of a slot if the PSFCH feedback is within a remaining channel occupancy duration after performing CAT 2 LBT if the gap is more than 16 to 25 μs, where the PSFCH feedback is transmitted for different cast types and different groupcast HARQ feedback options.

In certain embodiments, PSFCH feedback may be transmitted only to destination identifiers (“IDs”) that initiate a channel occupancy time (“COT”). In such embodiments, PSFCH feedback may be transmitted to any destination ID as long as at least one PSFCH transmission is transmitted to the transmit (“TX”) UE that initiated the channel occupancy.

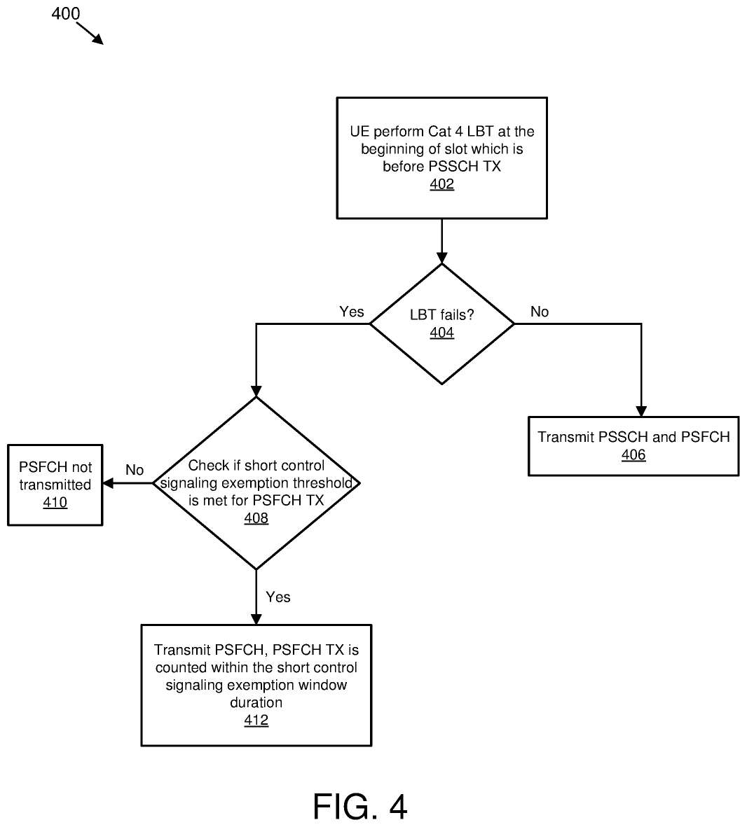

In a first embodiment, there may be LBT operation for PSFCH transmission. In the first embodiment, such as for sidelink design, PSFCH symbols (e.g., symbol 11, symbol 12) is time division multiplexed (“TDMed”) with the PSSCH symbols in a slot as shown in the FIG. 4, and a UE performs LBT at the beginning of the sidelink slot and, if LBT is successful, the UE performs PSSCH and PSFCH transmission. However as shown in FIG. 4, if LBT fails at the beginning of the sidelink slot then, PSSCH may not be transmitted but PSFCH may still be transmitted by considering PSFCH transmission under short control signaling exemption which means the PSFCH transmission does not exceed the threshold set for the short control signaling exemption. For example, in a 100 ms window, the total duration of the short control signaling exemption transmission does not exceed 10 ms.

FIG. 4 is a schematic block diagram illustrating one embodiment of a method 400 for LBT operation for PSFCH transmissions. In a step 402, a UE performs CAT 4 LBT at the beginning of a slot which is before a PSSCH transmission. In a step 404, the UE may determine a result of the CAT 4 LBT. For example, the UE may determine an LBT success or an LBT failure based at least in part on the performed CAT 4 LBT. If the UE determines that the result of the CAT 4 LBT is an LBT failure, in a step 406, the UE may perform a PSSCH transmission and PSFCH transmission. Otherwise, if the UE determines that the result of the CAT 4 LBT is an LBT success, in step 408, the UE may determine whether a short control signaling exemption threshold is met for a PSFCH transmission. If the UE determines that the threshold is not met, in step 410, the UE may refrain from performing the PSFCH transmission. If the threshold is met, in step 412, the UE may perform the PSFCH transmission, and the PSFCH transmission is counted within a short control signaling exemption window duration.

In certain embodiments, if a number of PSFCH transmission exceeds a threshold set for a short control signaling exemption (e.g., the total duration of the PSFCH transmission exceeds the 10 ms within a 100 ms window), then an LBT may need to be performed for the PSFCH transmission. In such embodiments, CAT 4 LBT may be performed before the PSFCH transmission in the guard symbol for guard symbol 10 while the CAPC priority value to be used for initiating channel occupancy using CAT 4 LBT for PSFCH transmission providing HARQ-ACK information may be the same as that of the priority value used for initiating channel occupancy of the corresponding PSSCH transmissions for which the HARQ-ACK was generated. In some embodiments, while initiating channel occupancy for multiple PSFCH transmissions, the highest priority value (e.g., lowest CAPC value number) may be used corresponding to those priority values used for initiating channel occupancy for the PSSCH transmission. In various embodiments, a CAPC priority value to be used for initiating channel occupancy may be configured (or preconfigured) for PSFCH. In certain embodiments, a CAPC priority value may be configured (or preconfigured) per resource pool. In FIG. 4, PSFCH may be transmitted using the rule set forth for the short control signaling exemption and any such PSFCH transmission under the short control signaling exemption may need to exclude a duration of PSFCH transmitted within a COT after a successful CAT2 and/or CAT 4 LBT.

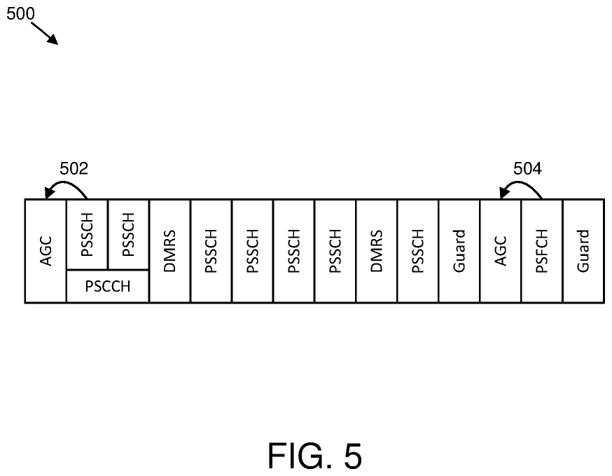

FIG. 5 is a schematic block diagram illustrating one embodiment of a sidelink slot structure 500. Dedicated symbols 502 and 504 are shown within the slot structure having 14 sidelink symbols available. The sidelink slot structure 500 includes symbols for automatic gain control (“AGC”), PSSCH, physical sidelink control channel (“PSCCH”), demodulation reference signal (“DMRS”), guard, and PSFCH.

In certain embodiments, as shown in FIG. 5, a remote unit 102 (e.g., UE) performs LBT before PSFCH transmission and PSFCH may be transmitted within a COT acquired after a successful CAT2 and/or CAT 4 LBT for the purpose of PSSCH transmission or PSFCH transmission. The corresponding PSFCH transmission within COT may not be counted as a short control signaling exemption and such PSFCH transmission may not be used to determine a duration set for the short control signaling exemption. In some embodiments, if LBT fails before PSFCH transmission, PSFCH may still be transmitted using a rule set forth for a short control signaling exemption and any such PSFCH transmission under the short control signaling exemption may need to exclude duration of PSFCH transmitted within a COT after a successful CAT2 and/or CAT 4 LBT.

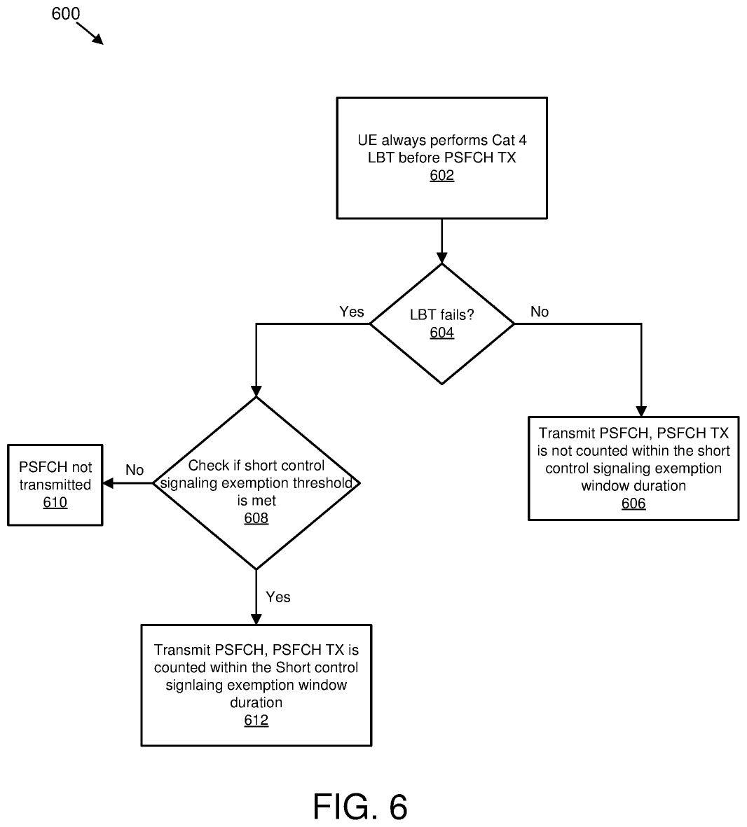

FIG. 6 is a schematic block diagram illustrating one embodiment of a method 600 for PSFCH transmission using LBT and a short control signaling exemption. In a step 602, a UE performs CAT 4 LBT before a PSFCH transmission. In a step 604, the UE may determine a result of the CAT 4 LBT. For example, the UE may determine an LBT success or an LBT failure based at least in part on the performed CAT 4 LBT. If the UE determines that the result of the CAT 4 LBT is an LBT failure, in a step 606, the UE may perform a PSFCH transmission and PSFCH transmission is not counted within the short control signaling exemption window duration. Otherwise, if the UE determines that the result of the CAT 4 LBT is an LBT success, in step 608, the UE may determine whether a short control signaling exemption threshold is met for a PSFCH transmission. If the UE determines that the threshold is not met, in step 610, the UE may refrain from performing the PSFCH transmission. If the threshold is met, in step 612, the UE may perform the PSFCH transmission, and the PSFCH transmission is counted within a short control signaling exemption window duration.

In various embodiments, CAT 2 LBT may need to be performed by a UE for PSFCH transmission within a COT (e.g., which is acquired after a successful CAT 4 LBT for the purpose of PSSCH and/or PSCCH transmissions) if the gap is more than 16 to 25 μs. In certain embodiments, CAT 2 LBT may need to be performed by a UE for PSSCH transmission within a COT if the gap is more than 16 to 25 μs.

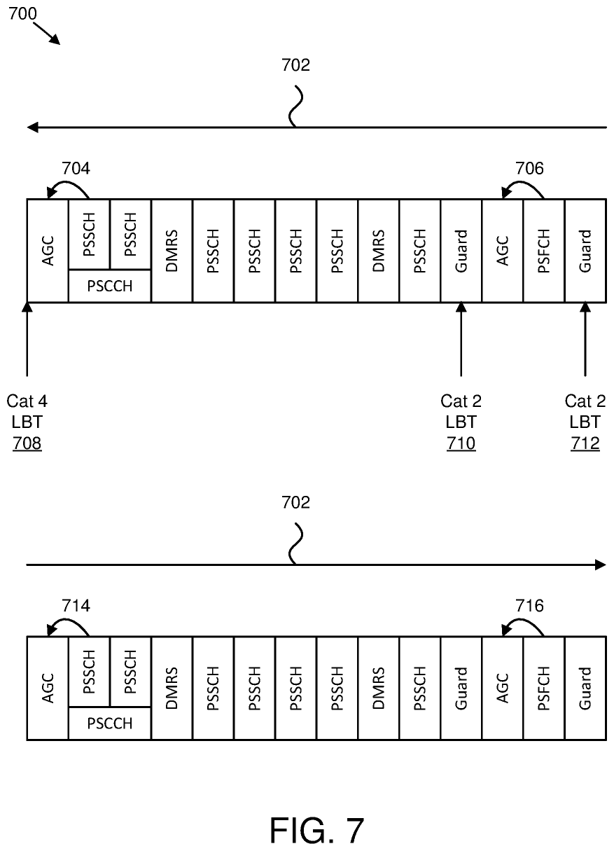

FIG. 7 is a schematic block diagram illustrating one embodiment of a CAT 2 LBT within a sidelink slot structure 700. A COT 702 is illustrated. Moreover, dedicated symbols 704 and 706 are shown within a first part of the sidelink slot structure 700 having 14 sidelink symbols available. The sidelink slot structure 700 includes symbols for AGC, PSSCH, PSCCH, DMRS, guard, and PSFCH. At a time 708, a UE performs a CAT 4 LBT. Further, at a time 710, the UE performs a CAT 2 LBT, and at a time 712, the UE performs a CAT 2 LBT. Moreover, dedicated symbols 714 and 716 are shown within a second part of the sidelink slot structure 700 having 14 sidelink symbols available.

In certain embodiments, PSFCH feedback may be transmitted within a set of symbols of a slot that are within a remaining channel occupancy duration after performing CAT 2 LBT if the gap is more than 16 to 25 μs, where the PSFCH feedback is transmitted for different cast types and different groupcast HARQ feedback options.

In some embodiments, PSFCH feedback may be transmitted only to destination IDs that initiate COT sharing or are indicated in the COT sharing, while receive (“RX”) UEs, after receiving the COT sharing indicator, may transmit ‘N’ HARQ feedback using ‘M’ PSFCH resources corresponding to the received PSSCH for the destination IDs.

In various embodiments, an RX UE may transmit ‘M’ PSFCH corresponding to a received PSSCH. In the remaining CO for all TX UEs transmitted to any destination IDs as long as at least one PSFCH transmission is made to the TX UE that initiates a channel occupancy.

In certain embodiments, for groupcast HARQ feedback option 1 (e.g., common NACK), UEs which are within a minimum communication range (“MCR”) may need to perform CAT 2 LBT before transmission of NACK feedback using a PSFCH resource.

In some embodiments, for groupcast HARQ feedback option 2 (e.g., dedicated ACK and/or NACK), UEs may need to perform CAT 2 LBT before the transmission of the HARQ feedback using a PSFCH resource.

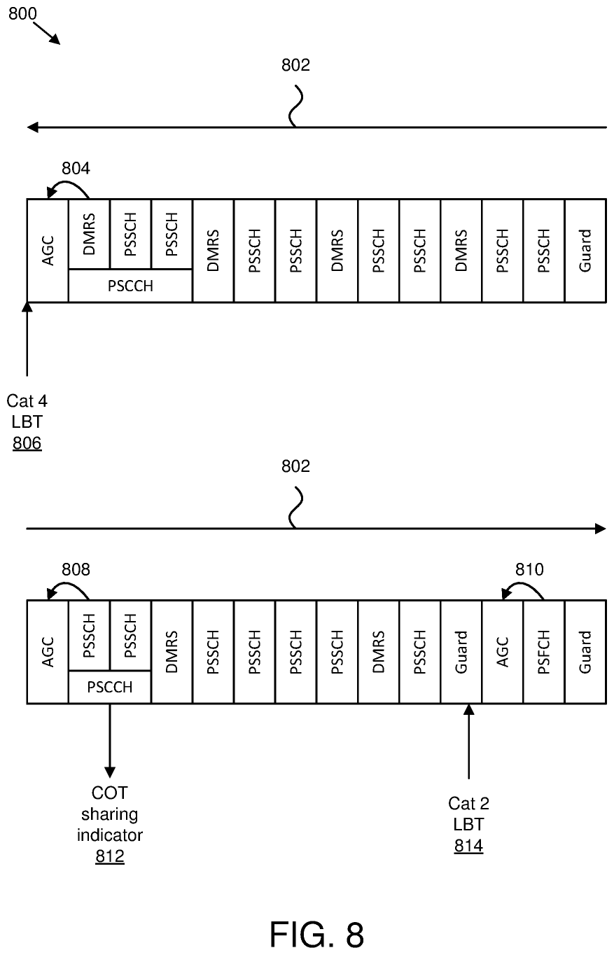

FIG. 8 is a schematic block diagram illustrating one embodiment of COT sharing for PSFCH transmission within a sidelink slot structure 800. A COT 802 is illustrated. Moreover, dedicated symbol 804 is shown within a first part of the sidelink slot structure 800 having 14 sidelink symbols available. The sidelink slot structure 800 includes symbols for AGC, PSSCH, PSCCH, DMRS, guard, and PSFCH. At a time 806, a UE performs a CAT 4 LBT. Moreover, dedicated symbols 808 and 810 are shown within a second part of the sidelink slot structure 800 having 14 sidelink symbols available. At a time 812, the UE transmits a COT sharing indicator. Further, at a time 814, the UE performs a CAT 4 LBT.

In a second embodiment, there may be a PSFCH resource determination. If L sub-channels in a resource pool and N PSSCH slots are associated with a slot containing PSFCH, there are then N·L sub-channels associated with a PSFCH symbol. With M PRBs available for PSFCH in a PSFCH symbol, there are M PRBs available for the HARQ feedback of transmissions over N L sub-channels. With M configured to be a multiple of N·L, then a distinct set of Mset=M/(N L) PRBs can be associated with the HARQ feedback for each sub-channel within a PSFCH. In the second embodiment, the N PSSCH slots associated within the channel occupancy duration may be associated with a slot containing PSFCH resource provided by sl-MinTimeGapPSFCH configuration in a resource pool after a last slot of the PSSCH reception within the channel occupancy duration. The PSSCH slots outside the channel occupancy duration where the UE did not make any transmission may not be associated to a slot containing PSFCH resource.

In certain embodiments, if a UE is not be able to transmit in a PSFCH resource outside the channel occupancy duration provided by sl-MinTimeGapPSFCH configuration in a resource pool after a last slot of the PSSCH reception within the channel occupancy duration, the UE may be able to perform LBT for the transmission of PSFCH and the PSSCH slots within the previous channel occupancy duration associated with the PSFCH slots, may start in the ascending order of the PSSCH time slot, and may continue in an ascending order of PSSCH sub-channel within the previous channel occupancy duration.

In some embodiments, a distinct set of Mset=M/(N·L) PRBs of PSFCH may be associated with the HARQ feedback for each of the L sub-channels within a PSFCH period and may only be associated with N PSSCH transmission slots performed within the channel occupancy duration, which means Mset PRBs of PSFCH may not be associated with HARQ feedback for each of the L sub-channels and N PSSCH slots outside the channel occupancy duration.

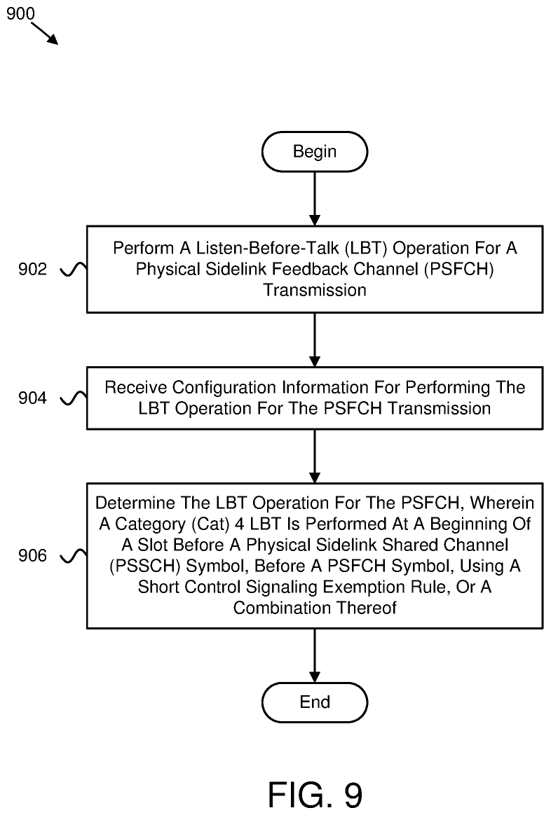

FIG. 9 is a flow chart diagram illustrating one embodiment of a method 900 for performing LBT operations for physical sidelink feedback channel transmissions. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes performing 902, at a user equipment, a LBT operation for a physical sidelink feedback channel (PSFCH) transmission. In some embodiments, the method 900 includes receiving 904 configuration information for performing the LBT operation for the PSFCH transmission. In certain embodiments, the method 900 includes determining 906 the LBT operation for the PSFCH. A CAT 4 LBT is performed at a beginning of a slot before a physical sidelink shared channel (PSSCH) symbol, before a PSFCH symbol, using a short control signaling exemption rule, or a combination thereof.

In certain embodiments, the configuration information comprises a channel access priority class (CAPC) priority, a PSFCH aggregation, or a combination thereof. In some embodiments, the method 900 further comprises performing Cat 2 LBT before PSFCH transmission within a remaining channel occupancy duration. In various embodiments, the method 1000 further comprises determining to transmit a PSFCH using a short control signaling exemption after LBT failure and before a PSFCH transmission.

In one embodiment, a PSFCH transmission within a channel occupancy duration is not counted for a short control signaling exemption window duration. In certain embodiments, PSFCH feedback is transmitted within the remaining channel occupancy duration for different cast types and different groupcast HARQ feedback options.

In some embodiments, PSFCH feedback is transmitted only to destination IDs that initiate a channel occupancy time (COT). In various embodiments, PSFCH feedback is transmitted to any destination ID as long as at least one PSFCH transmission to a TX UE that initiated a channel occupancy is made.

In one embodiment, a method comprises: receiving a configuration of a listen-before-talk (LBT) procedure associated with a physical sidelink feedback channel (PSFCH) transmission; and performing the LBT procedure based at least in part on the received configuration of the LBT procedure associated with the PSFCH transmission, wherein the LBT procedure comprises a category (CAT) 4, (CAT) 2 LBT, and wherein the LBT procedure is performed using one or more beginning symbols of a slot before one or more symbols associated with a physical sidelink shared channel (PSSCH) transmission, before one or more symbols associated with the PSFCH transmission, or using a short control signaling exemption rule, or a combination thereof.

In certain embodiments, the configuration comprises a channel access priority class (CAPC) priority indicating to initiate a channel occupancy procedure, a PSFCH aggregation factor indicating a number of consecutive sidelink (SL) slots, or a combination thereof.

In some embodiments, the method further comprises performing a CAT 2 LBT before the PSFCH transmission and within a remaining channel occupancy duration.

In various embodiments, the method further comprises determining to transmit a PSFCH using a short control signaling exemption after LBT failure and before a PSFCH resource.

In one embodiment, the PSFCH transmission within a channel occupancy duration is not counted for a short control signaling exemption window duration.

In certain embodiments, the PSFCH transmission is transmitted within the remaining channel occupancy duration for different cast types and different groupcast HARQ feedback options.

In some embodiments, the PSFCH transmission is transmitted to destination IDs that initiate a channel occupancy time (COT).

In various embodiments, the PSFCH transmission is transmitted to any destination ID as long as at least one PSFCH transmission to a TX UE that initiated a channel occupancy is made.

In one embodiment, an apparatus comprises: a processor; and a memory coupled to the processor, the processor configured to cause the apparatus to: receive a configuration of a listen-before-talk (LBT) procedure associated with a physical sidelink feedback channel (PSFCH) transmission; and perform the LBT procedure based at least in part on the received configuration of the LBT procedure associated with the PSFCH transmission, wherein the LBT procedure comprises a category (CAT) 4, (CAT) 2 LBT, and wherein the LBT procedure is performed using one or more beginning symbols of a slot before one or more symbols associated with a physical sidelink shared channel (PSSCH) transmission, before one or more symbols associated with the PSFCH transmission, or using a short control signaling exemption rule, or a combination thereof.

In certain embodiments, the configuration comprises a channel access priority class (CAPC) priority indicating to initiate a channel occupancy procedure, a PSFCH aggregation factor indicating a number of consecutive sidelink (SL) slots, or a combination thereof.

In some embodiments, the processor is configured to cause the apparatus to perform a CAT 2 LBT before the PSFCH transmission and within a remaining channel occupancy duration.

In various embodiments, the processor is configured to cause the apparatus to determine to transmit a PSFCH using a short control signaling exemption after LBT failure and before a PSFCH resource.

In one embodiment, the PSFCH transmission within a channel occupancy duration is not counted for a short control signaling exemption window duration.

In certain embodiments, the PSFCH transmission is transmitted within the remaining channel occupancy duration for different cast types and different groupcast HARQ feedback options.

In some embodiments, the PSFCH transmission is transmitted to destination IDs that initiate a channel occupancy time (COT).

In various embodiments, the PSFCH transmission is transmitted to any destination ID as long as at least one PSFCH transmission to a TX UE that initiated a channel occupancy is made.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving a configuration of a listen-before-talk (LBT) procedure associated with a physical sidelink feedback channel (PSFCH) transmission; and
performing the LBT procedure based at least in part on the received configuration of the LBT procedure associated with the PSFCH transmission, wherein the LBT procedure comprises a category (CAT) 4, (CAT) 2 LBT, and wherein the LBT procedure is performed using one or more beginning symbols of a slot before one or more symbols associated with a physical sidelink shared channel (PSSCH) transmission, before one or more symbols associated with the PSFCH transmission, or using a short control signaling exemption rule, or a combination thereof.

2. The method of claim 1, wherein the configuration comprises a channel access priority class (CAPC) priority indicating to initiate a channel occupancy procedure, a PSFCH aggregation factor indicating a number of consecutive sidelink (SL) slots, or a combination thereof.

3. The method of claim 1, further comprising performing a CAT 2 LBT before the PSFCH transmission and within a remaining channel occupancy duration.

4. The method of claim 1, further comprising determining to transmit a PSFCH using a short control signaling exemption after LBT failure and before a PSFCH resource.

5. The method of claim 1, wherein the PSFCH transmission within a channel occupancy duration is not counted for a short control signaling exemption window duration.

6. The method of claim 1, wherein the PSFCH transmission is transmitted within the remaining channel occupancy duration for different cast types and different groupcast HARQ feedback options.

7. The method of claim 1, wherein the PSFCH transmission is transmitted to destination IDs that initiate a channel occupancy time (COT).

8. A user equipment (UE), comprising:
at least one memory; and
at least one processor coupled with the at least one memory and configured to cause the UE to:
receive a configuration of a listen-before-talk (LBT) procedure associated with a physical sidelink feedback channel (PSFCH) transmission; and
perform the LBT procedure based at least in part on the received configuration of the LBT procedure associated with the PSFCH transmission, wherein the LBT procedure comprises a category (CAT) 4, (CAT) 2 LBT, and wherein the LBT procedure is performed using one or more beginning symbols of a slot before one or more symbols associated with a physical sidelink shared channel (PSSCH) transmission, before one or more symbols associated with the PSFCH transmission, or using a short control signaling exemption rule, or a combination thereof.

9. The UE of claim 8, wherein the configuration comprises a channel access priority class (CAPC) priority indicating to initiate a channel occupancy procedure, a PSFCH aggregation factor indicating a number of consecutive sidelink (SL) slots, or a combination thereof.

10. The UE of claim 8, wherein the at least one processor is configured to cause the UE to perform a CAT 2 LBT before the PSFCH transmission and within a remaining channel occupancy duration.

11. The UE of claim 8, wherein the at least one processor is configured to cause the UE to determine to transmit a PSFCH using a short control signaling exemption after LBT failure and before a PSFCH resource.

12. The UE of claim 8, wherein the PSFCH transmission within a channel occupancy duration is not counted for a short control signaling exemption window duration.

13. The UE of claim 8, wherein the PSFCH transmission is transmitted within the remaining channel occupancy duration for different cast types and different groupcast HARQ feedback options.

14. The UE of claim 8, wherein the PSFCH transmission is transmitted to destination IDs that initiate a channel occupancy time (COT).

15. The UE of claim 8, wherein the PSFCH transmission is transmitted to any destination ID as long as at least one PSFCH transmission to a TX UE that initiated a channel occupancy is made.

16. A processor for wireless communication, comprising:
at least one controller coupled with at least one memory and configured to cause the processor to:
receive a configuration of a listen-before-talk (LBT) procedure associated with a physical sidelink feedback channel (PSFCH) transmission; and
perform the LBT procedure based at least in part on the received configuration of the LBT procedure associated with the PSFCH transmission, wherein the LBT procedure comprises a category (CAT) 4, (CAT) 2 LBT, and wherein the LBT procedure is performed using one or more beginning symbols of a slot before one or more symbols associated with a physical sidelink shared channel (PSSCH) transmission, before one or more symbols associated with the PSFCH transmission, or using a short control signaling exemption rule, or a combination thereof.

17. The processor of claim 16, wherein the configuration comprises a channel access priority class (CAPC) priority indicating to initiate a channel occupancy procedure, a PSFCH aggregation factor indicating a number of consecutive sidelink (SL) slots, or a combination thereof.

18. The processor of claim 16, wherein the at least one controller is configured to cause the processor to perform a CAT 2 LBT before the PSFCH transmission and within a remaining channel occupancy duration.

19. The processor of claim 16, wherein the at least one controller is configured to cause the processor to determine to transmit a PSFCH using a short control signaling exemption after LBT failure and before a PSFCH resource.

20. The processor of claim 16, wherein the PSFCH transmission within a channel occupancy duration is not counted for a short control signaling exemption window duration.
